(19) United States
(12) Patent Application Publication
(10) Pub. No.: US 2012/0121429 A1
(43) Pub. Date: May 17, 2012

(54) Concentric ring wind turbine

(76) Inventor: Herbert Williams, Palatka, FL (US)

(21) Appl. No.: 12/927,453

(22) Filed: Nov. 16, 2010

(51) Int. Cl. F03D 3/06

(52) U.S. Cl. 416/227 R

(57) ABSTRACT

A wind turbine for generating electrical power, the turbine having a rotating rotor assembly mounted onto a support structure, the rotor assembly having a rotating axle member, a plurality of rotating ring pair assemblies, each ring pair assembly having an inner ring member, an outer ring member and a plurality of blade members joining the inner ring to the outer ring, and a plurality of stay members connecting the ring members to the axle member in a concentric manner.

### BACKGROUND OF THE INVENTION

The invention relates generally to the field of fluid driven turbines, such as wind turbines, wherein electrical power is generated from airflow across rotor blades. More particularly, the invention relates to such turbines wherein the blades extend from a central rotating hub or shaft member to an outer annular rotating ring or rim member. Even more particularly, the invention relates to such turbines wherein the blades are arranged in concentric rings.

Wind turbines, also known as windmills, wind generators, wind machines or the like, are well known devices for producing energy, typically electrical energy, by harnessing the power of wind. Typical wind turbines are very large structures, standing hundreds of feet tall and having rotor blades extending hundreds of feet, the rotor blades being mounted to a central hub or shaft. Large elongated blades are required since the area of blade sweep is proportional to the power that can be produced by a given wind turbine. This size creates a problem, in that each blade must act as a cantilever that can support the elongated blade and the blades must be increasingly massive toward the central hub in order to preclude the blade from breaking during use. Even with the use of high tech composites, carbon fibers and the like, a practical limit has been reached. For example, most large wind turbines have three blades, as this has been found to be the most efficient design. The desire to increase blade length in order to capture more wind is offset by the accompanying reduction in shaft revolutions per minute (rpm). Reduced rpm's require larger reduction gearboxes, which is undesirable. Decreasing, blade pitch in order to increase the rpm's reduces torque, which is undesirable. In addition, repair or replacement of these giant blades is difficult and can be extremely expensive. The cost of upkeep and repair reduces the overall benefits of energy production using wind technology. Thus, known wind turbine designs always have to make sacrifices in order to balance these competing factors.

An alternative type of wind turbine incorporates an outer, annular ring or rim that is joined to the blades, such that the blade tips are no longer self-supporting and thereby allowing the blades to be lighter and/or longer, easier to manufacture and repair, etc. The blades extend from the central rotating hub or shaft to the annular rim and are therefore supported at both ends. In this embodiment, it is also known to capture the rotational energy from the rotating annular rim rather than capturing the rotational energy directly from the central hub, since a point on the annular rim travels at a much faster rate than a point on the central hub. Rollers, wheels, gears, magnets, cables or the like are used to transfer the rotational energy from the rim to one or more generator mechanisms or the like. Examples of such turbines are shown in U.S. Pat. No. 4,319,865 to Richard, U.S. Pat. No. 4,330,714 to Smith, U.S. Pat. No. 4,350,895 to Cook, U.S. Pat. No. 4,545,729 to Storm, U.S. Pat. No. 4,729,716 to Schmidt, U.S. Pat. No. 6,664,655 to Vann, and U.S. Pat. No. 7,399,162 to Williams. Such wind turbines are often of smaller size and utilize sail-like blades rather than complicated blade structures in order to increase the number of wind catching elements, since the weight of the annular rim adds structural problems to the design. The smaller structure allows for construction, installation and maintenance costs of the wind turbine to be much lower than typical wind turbines.

In some of this type of wind turbine, the rotor assembly comprises short blades arranged in concentric rings, such that no single blade extends from the central hub to the outer annular rim member. Examples of this structure can be seen in U.S. Pat. No. 4,213,737 to Gerhardt and in U.S. Pat. No. 4,319,865 to Richard. The structures of both of these patents require rigid radial supports extending from the central hub to the annular rim and comprise complicated mechanical assemblies forming and controlling the blades.

It is an object of this invention to provide an improved structure for a wind turbine that results in a more efficient, sturdy, low material cost, low repair cost apparatus, wherein short, lightweight, sheet-like blades are positioned between pairs of annular rings, the rings being maintained in position by guide wires extending from the rings to an extended axle.

### SUMMARY OF THE INVENTION

The invention is a wind turbine for generating electrical power, the wind turbine comprising a rotating rotor assembly mounted onto a support structure, the rotor assembly comprising a rotating axle member, a plurality of rotating ring pair assemblies, each ring pair assembly comprising an inner ring member, an outer ring member and a plurality of blade members joining the inner ring to the outer ring, and a plurality of stay members connecting the ring members to the axle member.

The axle member extends in the horizontal direction to either side of the ring pair assemblies, which are arranged in concentric manner, the outer diameter of the innermost ring pair assembly being less than the inner diameter of the next outermost ring pair assembly such that a space is present between adjacent ring pair assemblies. The ring members are supported and maintained in proper position by the stay members, consisting of guide wires, cables or the like, extending from both sides of each ring member to the axle member, such that no rigid members are required to connect the ring pairs to each other or to the axle member. The blade members extending between each ring member of each ring pair are preferably sail-like, being thin in cross-section in order to reduce overall weight. The orientation of each of the blade members is preferably adjustable to account for changes in wind velocity.

### BRIEF DESCRIPTION OF THE DRAWINGS

FIG. 1 is front view of the wind turbine.

FIG. 2 is side view of the invention, with the upper half of the rotor assembly shown in cross-section taken along line II-II of FIG. 1.

FIG. 3 is a view of a ring pair assembly with blade.

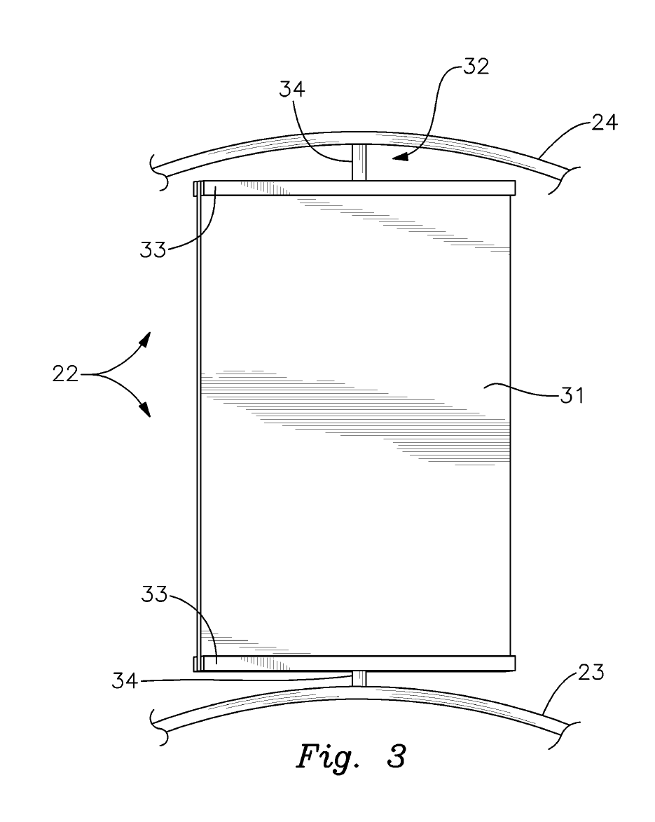

### DETAILED DESCRIPTION OF THE INVENTION

With reference to the drawings, the invention will now be described in detail with regard for the best mode and the preferred embodiment. In a broad sense, the invention is a fluid powered turbine, such as a wind turbine, where airflow rotates a rotor assembly, whereby electrical power or the like is generated by the rotational energy, and wherein the rotor assembly comprises a rotating axle member, a plurality of rotating ring pair assemblies, each ring pair assembly comprising an inner and an outer ring member joined to each other by a plurality of blade members, and a plurality of stay members connecting the ring members to the axle member.

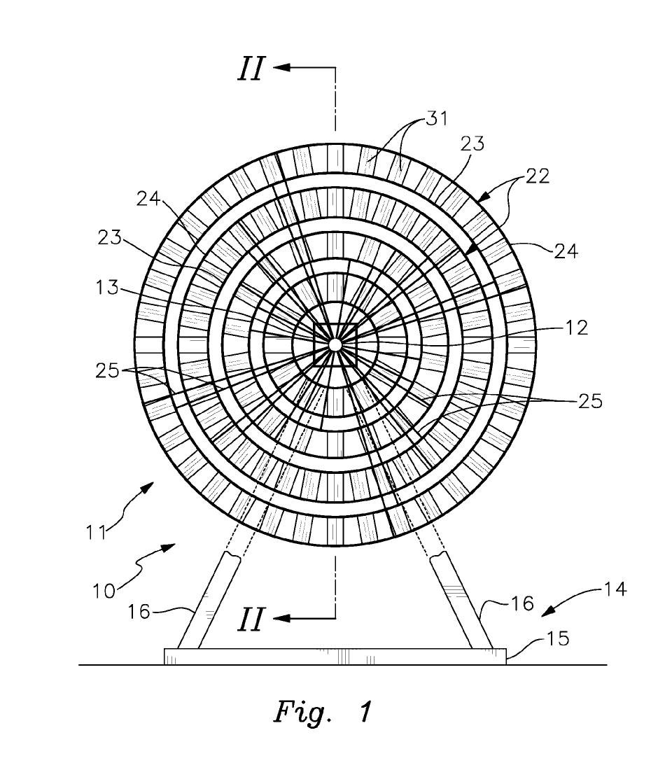

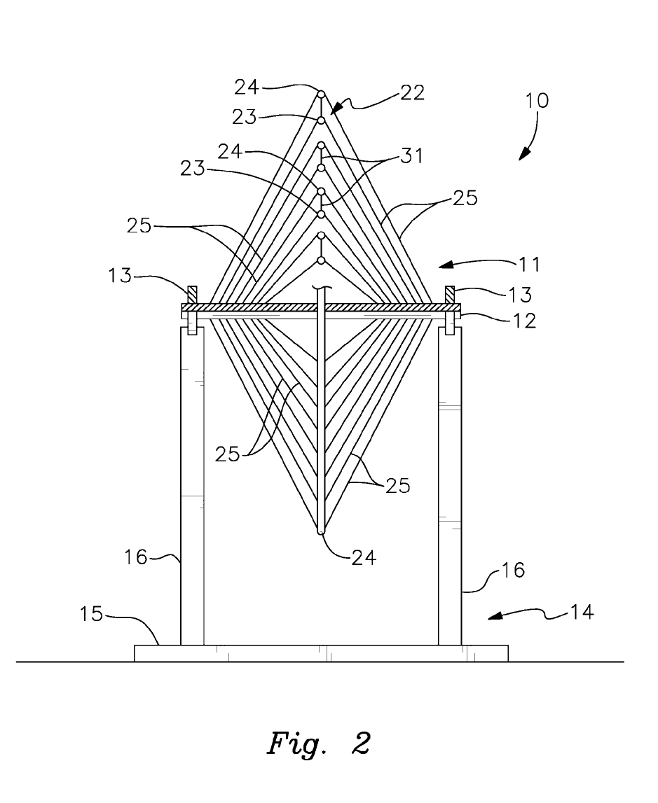

As shown in FIGS. 1 and 2, a typical wind turbine 10 comprises a rotor assembly 11 mounted onto a means for fixed support 14, such as a base 15 and tower member 16, whereby the rotor assembly 11 is positioned to have a generally horizontal axis of rotation in order to capture wind passing across the ground surface. The turbine 10 may be of any size, and the structure as described herein is suitable for relatively large turbines, wherein the diameter of the rotor assembly 11 may be hundreds of feet.

The rotor assembly 11 comprises a central rotating axle member 12, which is mounted in suitable manner within bearing members 13 on the tower members 16 such that the rotor assembly 11 can rotate relative to the fixed support means 14. The rotor assembly 11 further comprises a plurality of rotating ring pair assemblies 22, each ring pair assembly 22 comprising an inner ring member 23 and an outer ring member 24 joined to each other by a plurality of blade members 31, the blade members 14 being the means to capture the energy of the wind and translate that energy into rotational movement, and a plurality of stay members 25 connecting the ring members 23 and 24 to the axle member 12.

Axle member 12 is an elongated rigid member, preferably tubular or hollow to conserve weight, and the ring pair assemblies 22 are positioned generally centrally on the axle member 12, preferably in a single plane perpendicular to the axis of the axle member 12. The axle member 12 is supported by the bearing members 13 sufficient distance from the center to allow space for attachment of multiple stay members 25 to the axle member 12 between the bearing members 13. Bearing members 13 are structured in known manner, such as with ball or roller bearings, to allow for relatively easy rotation of the axle member 12. The axle member 12 is supported a sufficient distance above the ground surface by the tower members 16 to allow the ring pair assemblies 22 to be situated a distance above the ground surface and base 15 such that rotation is not impeded.

The ring pair assemblies each comprise an inner ring member 23 and an outer ring member 24, the diameter of the inner ring member 23 being smaller than the outer ring member 23. The ring members 23 and 24 are rigid members such that movement of the ring members 23 and 24 out-of-round or flexing of the ring members out-of-plane is resisted. The ring members 23 and 24 may comprise for example tubular or curved beam components, in single or composite form.

The ring pair assemblies 22 each further comprise a plurality of blade members 31 connecting the inner and outer ring members 23 and 24 to each other. The blade members 31 are the members that capture the wind energy to cause rotation of the rotor assembly 11. The blade members 31 are preferably sheet-like, being relatively thin in cross-section to conserve weight. Preferably the blade members 31 are constructed in the form of multiple layers of a substantially stiff, cured polymer resin having elongated reinforcement members disposed within or between the layers, such as carbon fiber strands, such that the blade members 31 may flex slightly if twisted. Means for mounting the blade members 31 to the ring members 23 and 24 are provided. The blade members 31 may be mounted between brackets 33 that are connected to the ring members 23 and 24 by shafts 34. Alternatively, the blade members 31 may be connected to the ring members 23 and 24 by rigid mechanical constructs, flexible cables, or similar means.

The blade members 31 may be mounted in a fixed manner relative to the ring members 23 and 24, but preferably are mounted such that the angle of the blade members 31 relative to the plane containing the ring members 233 and 24 may be altered to account for variations in wind speed. In a more preferred embodiment, the means for mounting the blade members 31 comprises a powered apparatus that allows the angle of the blade members 31 to be altered by a remote control system. Such systems are well known in the industry.

In the preferred embodiment the blade members 31 are sufficiently strong to secure the ring members 23 and 24 in a fixed orientation without the need for additional rigid or flexible connection members, for example beams, cables, etc., extending between the ring members 23 and 24 themselves. Alternatively, such rigid or flexible connection members may be present to increase the rigidity of the ring pair assembly 22.

A plurality of ring pair assemblies 22 of differing sizes comprises the rotor assembly 11. The outer diameter of the outer ring member 24 of the first or innermost ring pair assembly 22 is less than the inner diameter of the inner ring member 24 of the second or next adjacent ring pair assembly 22, such that a space or gap exists between the two adjacent ring pair assemblies 22. Likewise the outer diameter of the outer ring member 24 of the second ring pair assembly 22 is less than the inner diameter of the inner ring member 24 of the third ring pair assembly 22, such that a space or gap exists between these two adjacent ring pair assemblies 22. This continues for all the ring assemblies 22 present in a given wind turbine 10.

The ring pair assemblies 22 are mounted to the axle member 12 by a plurality of stay members 25. Stay members 25 comprise cables, wires or similar members of high strength. A plural number of stay members 25 extend at an acute angle from each ring member 23 and 24 to the axle member 12. For a given ring member 23 or 24, some of the stay members 25 extend to one side and other stay members extend to the other side. For example, as shown in the drawings, for each ring member 23 or 24, four stay members 25 extend to the axle member 12 on one side and four stay members 25 extend to the axle member 12 on the other side. With the four ring pair assemblies 22 as shown in the drawings, this structure results in 32 stay members 25 extending to one side and 32 stay members 25 extending to the other side.

In this manner, each ring member 23 and 24 and each ring pair assembly 22 are secured and maintained in position only by the combination of stay members 25 that extend to both sides of the ring pair assembly 22. No rigid or flexible bracing members connecting adjacent ring pair assemblies 22 to each other are required for stability of the rotor assembly 11. The ring pair assemblies 22 are independently mounted on the axle member 12.

Preferably the ring pair assemblies 22 are positioned concentrically in a single plane, as shown in the drawings, but it would also be possible to shift the individual ring pair assemblies 22 in the axial direction. In this manner the ring pair assemblies 22 could be disposed in a cone-like configuration or alternated back and forth.

The wind turbine 10 as described has multiple advantages over many conventional wind turbine structures. The gaps between the adjacent ring pair assemblies 22 allow a portion of the wind flow to pass through the rotor assembly 11 undisturbed. The axle member 12 is supported at both ends rather than just on one end. The blade members 31 are lighter and less expensive per square meter of blade surface area than many conventional blades. The blade members 31 are easily stacked for transportation. A given wind turbine 10 is scalable, even one currently in use, in that one or more ring pair assemblies 22 may be added or removed as desired. The axle member 12 alignment and the proper orientation of the ring members 23 and 24 are maintained by the stay members 25. The alignment and orientation of the ring pair assemblies 22 are maintained by the blade members 31 themselves. Individual blade members 31 are easily replaced.

It is understood that equivalents and substitutions for certain elements set forth above may be obvious to those skilled in the art, and therefore the true scope and definition of the invention is to be as set forth in the following claims. The embodiments shown in the drawings are presented for illustration and disclosure purposes, and the drawings are not intended to limit the invention.

I claim:

1. A wind turbine comprising:
a rotor assembly comprising an elongated rotating axle member, a plurality of rotating ring pair assemblies, each said ring pair assembly comprising an inner ring member and an outer ring member joined to each other by a plurality of blade members, and a plurality of stay members connecting said inner and outer ring members to said axle member, wherein said ring pair assemblies are independently mounted on said axle member.

2. The wind turbine of claim 1, wherein said ring pair assemblies are positioned concentrically on said axle member.

3. The wind turbine of claim 2, wherein said ring pair assemblies are positioned concentrically on said axle member in a single plane.

4. The wind turbine of claim 2, wherein said ring pair assemblies are positioned concentrically on said axle member such that a gap is present between adjacent ring pair assemblies.

5. The wind turbine of claim 1, wherein said stay members extend to said axle member on both sides of said inner and outer ring members.

6. The wind turbine of claim 1, wherein said stay members are composed of cable or wire.

7. The wind turbine of claim 1, wherein said blade members are sheet-like members thin in cross-section.

8. The wind turbine of claim 1, wherein the angle of said blade members relative to a plane containing said ring members is adjustable.

9. The wind turbine of claim 8, wherein the angle of said blade members relative to the plane containing said ring members is adjustable by a remote control system.

10. A wind turbine comprising:
a rotor assembly comprising an elongated rotating axle member, a plurality of rotating ring pair assemblies, each said ring pair assembly comprising an inner ring member and an outer ring member joined to each other by a plurality of blade members, and a plurality of stay members connecting said inner and outer ring members to said axle member, wherein said ring pair assemblies are independently mounted on said axle member and said stay members alone are sufficient to maintain the position of said ring pair assemblies relative to said axle member.

11. The wind turbine of claim 10, wherein said ring pair assemblies are positioned concentrically on said axle member.

12. The wind turbine of claim 11, wherein said ring pair assemblies are positioned concentrically on said axle member in a single plane.

13. The wind turbine of claim 11, wherein said ring pair assemblies are positioned concentrically on said axle member such that a gap is present between adjacent ring pair assemblies.

14. The wind turbine of claim 10, wherein said stay members extend to said axle member on both sides of said inner and outer ring members.

15. The wind turbine of claim 10, wherein said stay members are composed of cable or wire.

16. The wind turbine of claim 10, wherein said blade members are sheet-like members thin in cross-section.

17. The wind turbine of claim 1, wherein the angle of said blade members relative to a plane containing said ring members is adjustable.

18. The wind turbine of claim 17, wherein the angle of said blade members relative to the plane containing said ring members is adjustable by a remote control system.

19. The wind turbine of claim 10, further comprising a tower member supporting said rotor assembly.

20. A wind turbine comprising:
a rotor assembly comprising an elongated rotating axle member, a plurality of rotating ring pair assemblies positioned concentrically on said axle member such that a gap is present between adjacent ring pair assemblies, each said ring pair assembly comprising an inner ring member and an outer ring member joined to each other by a plurality of blade members, and a plurality of stay members connecting said inner and outer ring members to said axle member, wherein said stay members extend to said axle member on both sides of said inner and outer ring members, and wherein said ring pair assemblies are independently mounted on said axle member and said stay members alone are sufficient to maintain the position of said ring pair assemblies relative to said axle member.
